(19) United States
(12) Patent Application Publication
(10) Pub. No.: US 2026/0095909 A1
(43) Pub. Date: Apr. 2, 2026

(54) UL PRECODING SCHEMES FOR FULL COHERENT UE AND NON-COHERENT UE WITH EIGHT ANTENNA PORTS

(71) Applicant: LENOVO (BEIJING) LIMITED, Beijing (CN)

(72) Inventors: Bingchao LIU, Beijing (CN); Lingling XIAO, Beijing (CN)

(21) Appl. No.: 19/110,313

(22) PCT Filed: Sep. 29, 2022
(86) PCT No.: PCT/CN2022/122549

§ 371 Date: Mar. 10, 2025

(51) Int. Cl. H04W 72/1268; H04B 7/0456; H04W 72/232

(52) U.S. Cl. CPC H04W 72/1268; H04B 7/0456; H04W 72/232

(57) ABSTRACT

Methods and apparatuses for UL precoding schemes for full coherent UE and non-coherent UE with eight antenna ports are disclosed. In one embodiment, a UE comprises a transceiver; and a processor coupled to the transceiver, wherein the processor is configured to receive, via the transceiver, a DCI scheduling a PUSCH, wherein the DCI includes a TPMI field indicating information on a precoding matrix; and determine the precoding matrix for the scheduled PUSCH according to the TPMI field.

### FIELD

The subject matter disclosed herein generally relates to wireless communications, and more particularly relates to methods and apparatuses for UL precoding schemes for full coherent UE with eight antenna ports and non-coherent UE with eight antenna ports.

### BACKGROUND

The following abbreviations are herewith defined, at least some of which are referred to within the following description: New Radio (NR), Very Large Scale Integration (VLSI), Random Access Memory (RAM), Read-Only Memory (ROM), Erasable Programmable Read-Only Memory (EPROM or Flash Memory), Compact Disc Read-Only Memory (CD-ROM), Local Area Network (LAN), Wide Area Network (WAN), User Equipment (UE), Evolved Node B (eNB), Next Generation Node B (gNB), Uplink (UL), Downlink (DL), Central Processing Unit (CPU), Graphics Processing Unit (GPU), Field Programmable Gate Array (FPGA), Orthogonal Frequency Division Multiplexing (OFDM), Radio Resource Control (RRC), User Entity/Equipment (Mobile Terminal), Transmitter (TX), Receiver (RX), Physical Uplink Shared Channel (PUSCH), codebook (CB), non-codebook (nCB), Sounding Reference Signal (SRS), Bandwidth part (BWP), Channel State Information Reference Signal (CSI-RS), Downlink Control Information (DCI), Transmit Precoding Matrix Indicator (TPMI), Demodulation Reference Signal (DMRS), Discrete Fourier Transform (DFT), Customer Premise Equipment (CPE), Fixed Wireless Access (FWA).

PUSCH transmission with 8 antenna ports (8Tx PUSCH) shall be supported in NR Release 18 for advanced UE equipped with 8 antennas with one or multiple layers.

This disclosure targets UL precoding schemes for full coherent UE with eight antenna ports and non-coherent UE with eight antenna ports.

### BRIEF SUMMARY

Methods and apparatuses for UL precoding schemes for full coherent UE and non-coherent UE with eight antenna ports are disclosed.

In one embodiment, a UE comprises a transceiver; and a processor coupled to the transceiver, wherein the processor is configured to receive, via the transceiver, a DCI scheduling a PUSCH, wherein the DCI includes a TPMI field indicating information on a precoding matrix; and determine the precoding matrix for the scheduled PUSCH according to the TPMI field.

In some embodiment, the processor is further configured to report, via the transceiver, the number of antenna groups (Ng).

In some embodiment, if the number of antenna groups (Ng) is 8 for the UE, the TPMI field contains a 8-bit bitmap b₇b₆b₅b₄b₃b₂b₁b₀, where, the number of non-zero bits in the 8-bit bitmap indicates the number of PUSCH layers of the scheduled PUSCH, each non-zero bit bᵢ indicates that antenna port 1000+i is used for PUSCH transmission, where i is from 0 to 7, and the n^{th} PUSCH layer of the scheduled PUSCH is transmitted by the n^{th} indicated antenna port 1000+i beginning from the smallest i of the non-zero bit bᵢ.

In some embodiment, if the number of antenna groups (Ng) is 1 for the UE, the DCI further includes an antenna port(s) field indicating the number of DMRS ports that determines a rank of the scheduled PUSCH, and the precoding matrix for the scheduled PUSCH is determined according to the rank and the TPMI field, and the processor is further configured to report, via the transceiver, the supported pairs of oversampling factors (Oₘ, Oₙ) in horizontal and vertical corresponding to the reported (M, N). If more than one pair of oversampling factors (Oₘ, Oₙ) is reported, the processor is further configured to receive, via the transceiver, a configuration to configure a pair of oversampling factors (Oₘ, Oₙ).

In some embodiment, if the number of antenna groups (Ng) is 1 for the UE and the UE only supports full-coherent precoding, the bitwidth of TPMI field is (┌log₂(OₘM)┐+┌log₂(OₙN)┐+2) bits for maxRank=1; and the bitwidth of TPMI field is (┌log₂(OₘM)┐+┌log₂(OₙN)┐+2+1) bits for maxRank=4 or 8. In particular, if the transmit rank of the scheduled PUSCH is 1, a m value, a n value and a l value are used for obtaining the precoding matrix for the scheduled PUSCH, and in the TPMI field, first ┌log₂(OₘM)┐ bit(s) indicate the m value, ┌log₂(OₙN)┐ bit(s) following the ┌log₂(OₘM)┐ bit(s) indicate the n value, and two bits following the ┌log₂(OₙN)┐ bit(s) indicate the l value. If the transmit rank of the scheduled PUSCH is 2 or 3 or 4, a m value, an value, a pair of (Δm, Δn) value and a l value are used for obtaining the precoding matrix for the scheduled PUSCH, and in the TPMI field, first ┌log₂(OₘM)┐ bit(s) indicate the m value, ┌log₂(OₙN)┐ bit(s) following the ┌log₂(OₘM)┐ bit(s) indicate the n value, two bits following the ┌log₂(OₙN)┐ bit(s) indicate the pair of (Δm, Δn) value, and the last one bit indicates the l value. If the transmit rank of the scheduled PUSCH is 5 or 6, a m value, a n value, a pair of (Δm, Δn) value and a l value are used for obtaining the precoding matrix for the scheduled PUSCH, and in the TPMI field, first ┌log₂(OₘM)┐ bit(s) indicate the m value, ┌log₂(OₙN)┐ bit(s) following the ┌log₂(OₘM)┐ bit(s) indicate the n value, and one bit following the ┌log₂(OₙN)┐ bit(s) indicates the l value, where, the pair of (Δm, Δn) value is predetermined. If the transmit rank of the scheduled PUSCH is 7 or 8 and the pair of (M, N) is (2, 2), a m value, a n value, a pair of (Δm, Δn) value and a l value are used for obtaining the precoding matrix for the scheduled PUSCH, and in the TPMI field, first ┌log₂(OₘM)┐ bit(s) indicate the m value, ┌log₂(OₙN)┐ bit(s) following the ┌log₂(OₘM)┐ bit(s) indicate the n value, and one bit following the ┌log₂(OₙN)┐ bit(s) indicates the l value, where, the pair of (Δm, Δn) value is predetermined. If the transmit rank of the scheduled PUSCH is 7 or 8 and the pair of (M, N) is (4, 1), a m value, a n value, a pair of (Δm, Δn) value and a l value are used for obtaining the precoding matrix for the scheduled PUSCH, and in the TPMI field, first

$$⌈ {log}_{2} ( \frac{{O}_{m} M}{2} ) ⌉$$

bit(s) indicate the m value, and one bit following the

$$⌈ {log}_{2} ( \frac{{O}_{m} M}{2} ) ⌉$$

bit(s) indicates the l value, where, the n value is predetermined, and the pair of (Δm, Δn) value is predetermined.

In another embodiment, a method performed at a UE comprises receiving a DCI scheduling a PUSCH, wherein the DCI includes a TPMI field indicating information on a precoding matrix; and determining the precoding matrix for the scheduled PUSCH according to the TPMI field.

In still another embodiment, a base unit comprises a transceiver; and a processor coupled to the transceiver, wherein the processor is configured to transmit, via the transceiver, a DCI scheduling a PUSCH, wherein the DCI includes a TPMI field indicating information on a precoding matrix; and determine the precoding matrix for the scheduled PUSCH according to the TPMI field.

In yet another embodiment, a method performed at a base unit comprises transmitting a DCI scheduling a PUSCH, wherein the DCI includes a TPMI field indicating information on a precoding matrix; and determining the precoding matrix for the scheduled PUSCH according to the TPMI field.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments, and are not therefore to be considered to be limiting of scope, the embodiments will be described and explained with additional specificity and detail through the use of the accompanying drawings, in which:

FIG. 1 illustrates several antenna layouts with different number of antenna groups;

FIG. 2 illustrates an example of antenna layout 1-a and antenna layout 1-b;

FIG. 3 illustrates the TPMI field for rank 1;

FIG. 4 illustrates the TPMI field for rank 2 or rank 3 or rank 4;

FIG. 5 illustrates the TPMI field for rank 5 or rank 6 or rank 7 with (M, N)=(2, 2) or rank 8 with (M, N)=(2, 2);

FIG. 6 illustrates the TPMI field for rank 7 with (M, N)=(4, 1) or rank 8 with (M, N)=(4, 1);

FIG. 7(a) illustrates the TPMI field for the scheduled rank 1 PUSCH when maxRank=4;

FIG. 7(b) illustrates the TPMI field for the scheduled rank 2 or rank 3 or rank 4 PUSCH when maxRank=4;

FIG. 8(a) illustrates the TPMI field for the scheduled rank 1 PUSCH when maxRank=8;

FIG. 8(b) illustrates the TPMI field for the scheduled rank 2 or rank 3 or rank 4 PUSCH when maxRank=8;

FIG. 8(c) illustrates the TPMI field for the scheduled rank 5 or rank 6 or rank 7 with (M, N)=(2, 2) or rank 8 with (M, N)=(2, 2) PUSCH when maxRank=8;

FIG. 8(d) illustrates the TPMI field for the scheduled rank 7 with (M, N)=(4, 1) or rank 8 with (M, N)=(4, 1) PUSCH when maxRank=8;

FIG. 9 is a schematic flow chart diagram illustrating an embodiment of a method;

FIG. 10 is a schematic flow chart diagram illustrating an embodiment of another method; and

FIG. 11 is a schematic block diagram illustrating apparatuses according to one embodiment.

### DETAILED DESCRIPTION

As will be appreciated by one skilled in the art that certain aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects that may generally all be referred to herein as a “circuit”, “module” or “system”. Furthermore, embodiments may take the form of a program product embodied in one or more computer readable storage devices storing machine-readable code, computer readable code, and/or program code, referred to hereafter as “code”. The storage devices may be tangible, non-transitory, and/or non-transmission. The storage devices may not embody signals. In a certain embodiment, the storage devices only employ signals for accessing code.

Certain functional units described in this specification may be labeled as “modules”, in order to more particularly emphasize their independent implementation. For example, a module may be implemented as a hardware circuit comprising custom very-large-scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in code and/or software for execution by various types of processors. An identified module of code may, for instance, include one or more physical or logical blocks of executable code which may, for instance, be organized as an object, procedure, or function. Nevertheless, the executables of an identified module need not be physically located together, but, may include disparate instructions stored in different locations which, when joined logically together, include the module and achieve the stated purpose for the module.

Indeed, a module of code may contain a single instruction, or many instructions, and may even be distributed over several different code segments, among different programs, and across several memory devices. Similarly, operational data may be identified and illustrated herein within modules and may be embodied in any suitable form and organized within any suitable type of data structure. This operational data may be collected as a single data set, or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing code. The storage device may be, for example, but need not necessarily be, an electronic, magnetic, optical, electromagnetic, infrared, holographic, micromechanical, or semiconductor system, apparatus, or device, or any suitable combination of the foregoing.

A non-exhaustive list of more specific examples of the storage device would include the following: an electrical connection having one or more wires, a portable computer diskette, a hard disk, random access memory (RAM), read-only memory (ROM), erasable programmable read-only memory (EPROM or Flash Memory), portable compact disc read-only memory (CD-ROM), an optical storage device, a magnetic storage device, or any suitable combination of the foregoing. In the context of this document, a computer-readable storage medium may be any tangible medium that can contain or store a program for use by or in connection with an instruction execution system, apparatus, or device.

Code for carrying out operations for embodiments may include any number of lines and may be written in any combination of one or more programming languages including an object-oriented programming language such as Python, Ruby, Java, Smalltalk, C++, or the like, and conventional procedural programming languages, such as the “C” programming language, or the like, and/or machine languages such as assembly languages. The code may be executed entirely on the user's computer, partly on the user's computer, as a stand-alone software package, partly on the user's computer and partly on a remote computer or entirely on the remote computer or server. In the very last scenario, the remote computer may be connected to the user's computer through any type of network, including a local area network (LAN) or a wide area network (WAN), or the connection may be made to an external computer (for example, through the Internet using an Internet Service Provider).

Reference throughout this specification to “one embodiment”, “an embodiment”, or similar language means that a particular feature, structure, or characteristic described in connection with the embodiment is included in at least one embodiment. Thus, appearances of the phrases “in one embodiment”, “in an embodiment”, and similar language throughout this specification may, but do not necessarily, all refer to the same embodiment, but mean “one or more but not all embodiments” unless expressly specified otherwise. The terms “including”, “comprising”, “having”, and variations thereof mean “including but are not limited to”, unless otherwise expressly specified. An enumerated listing of items does not imply that any or all of the items are mutually exclusive, otherwise unless expressly specified. The terms “a”, “an”, and “the” also refer to “one or more” unless otherwise expressly specified.

Furthermore, described features, structures, or characteristics of various embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid any obscuring of aspects of an embodiment.

Aspects of different embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. This code may be provided to a processor of a general purpose computer, special purpose computer, or other programmable data processing apparatus to produce a machine, such that the instructions, which are executed via the processor of the computer or other programmable data processing apparatus, create means for implementing the functions specified in the schematic flowchart diagrams and/or schematic block diagrams for the block or blocks.

The code may also be stored in a storage device that can direct a computer, other programmable data processing apparatus, or other devices, to function in a particular manner, such that the instructions stored in the storage device produce an article of manufacture including instructions which implement the function specified in the schematic flowchart diagrams and/or schematic block diagrams block or blocks.

The code may also be loaded onto a computer, other programmable data processing apparatus, or other devices, to cause a series of operational steps to be performed on the computer, other programmable apparatus or other devices to produce a computer implemented process such that the code executed on the computer or other programmable apparatus provides processes for implementing the functions specified in the flowchart and/or block diagram block or blocks.

The schematic flowchart diagrams and/or schematic block diagrams in the FIGURES illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which includes one or more executable instructions of the code for implementing the specified logical function(s).

It should also be noted that in some alternative implementations, the functions noted in the block may occur out of the order noted in the FIGURES. For example, two blocks shown in succession may substantially be executed concurrently, or the blocks may sometimes be executed in the reverse order, depending upon the functionality involved. Other steps and methods may be conceived that are equivalent in function, logic, or effect to one or more blocks, or portions thereof, to the illustrated FIGURES.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each Figure may refer to elements of proceeding figures. Like numbers refer to like elements in all figures, including alternate embodiments of like elements.

The UE can be configured in two different modes for PUSCH multi-antenna precoding, referred as codebook (CB) based transmission and non-codebook (nCB) based transmission, respectively. When the UE is configured with codebook based PUSCH transmission, one SRS resource set used for codebook can be configured in a BWP of a cell for the UE. When the UE is configured with non-codebook based PUSCH transmission, one SRS resource set used for non-codebook can be configured in a BWP of a cell for the UE.

To enable codebook based PUSCH transmission, the UE shall be configured to transmit one or more SRS resources used for codebook for uplink channel measurement. Based on the measurements on the configured SRS resources transmitted by the UE, the gNB determines a suitable rank and the precoding matrix from a pre-defined codebook, which includes a set of precoding matrices with different ranks, and sends the information to the UE when scheduling a PUSCH transmission.

For non-codebook based PUSCH transmission, the UE is required to measure a CSI-RS to obtain the uplink channel information based on channel reciprocity. In this case, a CSI-RS resource, which is a DL reference signaling transmitted by the gNB for DL channel measurement, is associated with the SRS resource set used for non-codebook. The UE selects what it believes is a suitable uplink precoder and applies the selected precoder to a set of configured SRS resources with one SRS resource transmitted on each layer defined by the precoder. Based on the received SRS resources, the gNB decides to modify the UE-selected precoder for the scheduled PUSCH transmission.

When a UE is equipped with 8 antenna ports (e.g., PUSCH or SRS antenna ports), the base unit (e.g., gNB) may send to the UE a DCI (e.g., DCI with format 0_1 or DCI with format 0_2) scheduling a PUSCH transmission with up to 8 layers (i.e., PUSCH layers). The 8 antenna ports (e.g., PUSCH or SRS antenna ports) may be numbered as PUSCH or SRS antenna ports 1000, 1001, 1002, 1003, 1004, 1005, 1006, and 1007.

When the PUSCH layers are transmitted from the UE, a precoding matrix is used to perform UL precoding on modulated data in codebook based PUSCH transmission. The UE shall perform UL precoding according to Equation 1.

$$[ \begin{matrix}{z}_{0}^{( {P}_{0} )} ( i ) \\ ⋮ \\ {z}_{0}^{( {P}_{ρ - 1} )} ( i )\end{matrix} ] = {W}_{0} [ \begin{matrix}{y}_{0}^{( 0 )} ( i ) \\ ⋮ \\ {y}_{0}^{( {v}_{0} - 1 )} ( i )\end{matrix} ] \qquad Equation 1$$

where, the block of vector

$${[ \begin{matrix}{y}_{0}^{( 0 )} ( i ) & ⋯ & {y}_{0}^{( {v}_{0} - 1 )} ( i )\end{matrix} ]}^{T}$$

is the modulated data that will be transmitted: W₀ is the precoding matrix applied to the block of vector; and the block of vector

$${[ \begin{matrix}{z}_{0}^{( {P}_{0} )} ( i ) & ⋯ & {z}_{0}^{( {P}_{ρ - 1} )} ( i )\end{matrix} ]}^{T}$$

is the pre-coded data to be transmitted by the UE. v₀ indicates the number of PUSCH layers. P₀ corresponds to PUSCH antenna port 1000 and P_{ρ-1} corresponds to PUSCH antenna port 1000+ρ−1. In this invention, ρ=8.

Coherent transmission is described as follows:

If a UE reports a capability of full-coherent and 8 antenna ports (i.e., PUSCH antenna port 1000, 1001, 1002, 1003, 1004, 1005, 1006 and 1007), all 8 PUSCH antenna ports can be used for coherent transmission of a PUSCH layer. For example, the precoding vector used for each layer can have 8 non-zero elements, e.g.,

$$W = {\frac{1}{2 \sqrt{2}} [ 1 , j , 1 , j , 1 , j , 1 , j ]}^{T}$$

is a valid precoding vector for a rank 1 PUSCH transmission with 8 full-coherent antenna ports. If the phase difference between any two antenna ports among multiple antenna ports is fixed, the multiple antenna ports are coherent. If the phase difference between any two antenna ports among multiple antenna ports is not fixed, the multiple antenna ports are non-coherent.

If a UE reports capability of partial-coherent or non-coherent with 8 antenna ports (i.e., PUSCH antenna port 1000, 1001, 1002, 1003, 1004, 1005, 1006 and 1007), only coherent antenna ports (where the coherent antenna ports are a part of the 8 antenna ports) can be used for transmission of one PUSCH layer. In particular, all 8 antenna ports are grouped as Ng antenna groups. All antenna ports within each antenna group are coherent, while antenna ports from different antenna groups are non-coherent. Several antenna layouts with different number of antenna groups are illustrated in FIG. 1.

In FIG. 1, Ng denotes the number of antenna groups. M denotes the number of antennas in vertical in an antenna group. N denotes the number of antennas in horizontal in an antenna group. P denotes the number of polarizations of each antenna. Each polarization of an antenna corresponds to an antenna ports

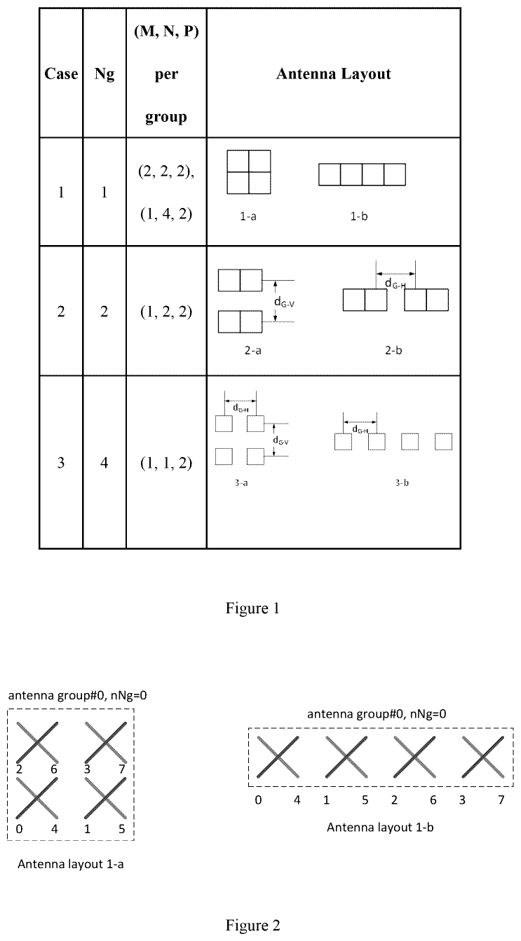

Antenna layout 1-a and antenna layout 1-b illustrated in FIG. 2 correspond to full coherent antenna array, i.e., all 8 antenna ports within each of antenna layout 1-a and antenna layout 1-b belong to one (i.e., Ng=1) antenna group (e.g., antenna group #0), denoted as nNg=0) are coherent antenna ports. So, if the UE reports Ng=1, then all the 8 antenna ports are coherent and the UE is a full coherent UE.

When 8 antenna ports belong to eight (i.e., Ng=8) antenna groups, each antenna group consists of only one antenna port. All the 8 antenna ports are non-coherent. So, if the UE reports Ng=8, the UE is a non-coherent UE.

Before discussing the codebook design, the UE needs to report its antenna layout including the number of antenna groups 1≤Ng≤8, and the antennas within each antenna group (M, N, P), where M indicates the number of antennas in horizontal, N indicates the number of antennas in vertical, P indicates the number of polarizations of each antenna. One polarization of each antenna corresponds to an antenna port. Each antenna group has the same antenna structure.

For full-coherent UE, i.e., Ng=1, a same precoding scheme shall be applied to antenna layouts 1-a and 1-b. For antenna layout 1-a, the parameters (M, N, P) are (2, 2, 2). For antenna layout 1-b, the parameters (M, N, P) are (4, 1, 2). It can be seen that the pair of (M, N) for UE with Ng=1 can be (2, 2) or (4, 1).

Ng=8 corresponds to non-coherent UE. That is, all 8 antennas are non-coherent.

The UE can report the supported maxRank∈{1, 2, 3, 4, 5, 6, 7, 8}, i.e., the supported maximum number of PUSCH layers for a PUSCH transmission.

The gNB sends a DCI to the UE to schedule one or more PUSCH transmissions. The rank of the scheduled PUSCH transmission may be 1, 2, 3, 4, 5, 6, 7 or 8 depending on the reported maxRank. It means that the PUSCH transmission has L PUSCH layers, where L is equal to the rank, which is equal to or less than the reported maxRank. A precoding matrix (which can also be referred to as precoder) shall be determined for the scheduled PUSCH transmission.

The number of columns of the precoding matrix is equal the number of layers (i.e., the rank) of a PUSCH transmission for which the precoding matrix can be applied. So, precoding matrix (i.e., precoder) can be further described as rank R precoding matrix (precoder), e.g., rank 1 precoder, rank 2 precoder, rank 3 precoder, rank 4 precoder, rank 5 precoder, rank 6 precoder, rank 7 precoder, rank 8 precoder. Rank R precoding matrix (precoder) can be also denoted as R-layer precoding matrix (precoder), e.g., one-layer precoder (or single-layer precoder), two-layer precoder, three-layer precoder, four-layer precoder, five-layer precoder, six-layer precoder, seven-layer precoder, eight-layer precoder. The number of rows of the precoding matrix (precoder) is equal to the number of antenna ports for which the precoding matrix can be applied. For example, the precoding matrix (precoder) shall have 8 rows (denoted as 8Tx) for a UE with 8 antenna ports.

A first embodiment relates to precoder and TPMI indication for non-coherent UE (i.e., UE with Ng=8).

Due to the random phase noise among the non-coherent UE antennas, each PUSCH layer shall be transmitted by one antenna port when full Tx power mode is not configured. In full Tx power mode, the UE is required to transmit the PUSCH transmit with the full maximum output power among all the antenna ports. So, port selection based precoding matrix should be specified for non-coherent UE.

The available rank 1 precoders for non-coherent UE include

$$\frac{1}{2 \sqrt{2}} \times {[ 1 , 0 , 0 , 0 , 0 , 0 , 0 , 0 ]}^{T} , \frac{1}{2 \sqrt{2}} \times {[ 0 , 1 , 0 , 0 , 0 , 0 , 0 , 0 ]}^{T} , \frac{1}{2 \sqrt{2}} \times {[ 0 , 0 , 1 , 0 , 0 , 0 , 0 , 0 ]}^{T} , \frac{1}{2 \sqrt{2}} \times {[ 0 , 0 , 0 , 1 , 0 , 0 , 0 , 0 ]}^{T} ,$$

$$\frac{1}{2 \sqrt{2}} \times {[ 0 , 0 , 0 , 0 , 1 , 0 , 0 , 0 ]}^{T} , \frac{1}{2 \sqrt{2}} \times {[ 0 , 0 , 0 , 0 , 0 , 1 , 0 , 0 ]}^{T} , \frac{1}{2 \sqrt{2}} \times {[ 0 , 0 , 0 , 0 , 0 , 0 , 1 , 0 ]}^{T} , and \frac{1}{2 \sqrt{2}} \times {[ 0 , 0 , 0 , 0 , 0 , 0 , 0 , 1 ]}^{T} .$$

When a UE receives a DCI scheduling a PUSCH transmission with n layers (where n is any one from 1 to 8), n out of 8 antenna ports need to be indicated to the UE for the scheduled PUSCH transmission, where each of n PUSCH layer is transmitted by one of indicated n antenna ports. A total number of

$${C}_{8}^{n}$$

precoding matrices can be indicated for PUSCH transmission with n layers. The numbers of available precoders for different ranks are illustrated in Table 1.

TABLE 1
Number of available precoders for each rank for non-coherent UE
with eight antenna ports

| Rank | 1 | 2 | 3 | 4 | 5 | 6 | 7 | 8 |
|---|---|---|---|---|---|---|---|---|
| Number of precoders | ${C}_{8}^{1} = 8$ | ${C}_{8}^{2} = 28$ | ${C}_{8}^{3} = 56$ | ${C}_{8}^{4} = 70$ | ${C}_{8}^{5} = 56$ | ${C}_{8}^{6} = 28$ | ${C}_{8}^{7} = 8$ | ${C}_{8}^{8} = 1$ |

For each maxRank, the candidate rank of the scheduled PUSCH can range from 1 to the maxRank. So, the available precoders for each maxRank are equal to the sum of the available precoders for the rank(s) ranging from 1 to the maxRank

$$( i . e . , {\sum }_{n = 1}^{maxR ank} ( {C}_{8}^{n} ) )$$

So, the required bits to indicate the precoders for different maxRank can be calculated by

$$⌈ {log}_{2} ( {\sum }_{n = 1}^{maxR ank} ( {C}_{8}^{n} ) ) ⌉ ,$$

where ┐x┌ is the smallest integer that is equal to or larger than x. Table 2 illustrates the required bits to indicate the precoders for each maxRank. For example, the required bits for rank=3 is

$$⌈ {log}_{2} ( {\sum }_{n = 1}^{3} ( {C}_{8}^{n} ) ) ⌉ = ⌈ {log}_{2} ( {C}_{8}^{1} + {C}_{8}^{2} + {C}_{8}^{3} ) ⌉ = ⌈ {log}_{2} ( 1 + 28 + 56 ) ⌉ = 7.$$

TABLE 2
Number of required bits to indicate the precoders for each
maxRank for non-coherent UE with eight antenna ports

| maxRank | 1 | 2 | 3 | 4 | 5 | 6 | 7 | 8 |
|---|---|---|---|---|---|---|---|---|
| Required bits | 3 | 6 | 7 | 8 | 8 | 8 | 8 | 8 |

It can be observed that the total number of complete orthogonal precoders for transmission of the PUSCH with all ranks (from 1 to 8) transmission is 255 (=8+28+56+70+56+28+8+1).

It is possible to configure all the 255 available precoders to the UE by RRC signaling, and indicate one of the 255 available precoders in TPMI field of the DCI scheduling the PUSCH. In this manner, the TPMI field shall have 8 bits to indicate one of the 255 available precoders. However, the configuration of all the 255 available precoders to the UE by RRC signaling wastes a lot of resources.

In view of the above, this disclosure proposes the following TPMI indication mechanism, which does not require configuring the 255 available precoders by RRC signaling.

For the UE with 1<=maxRank<=8, an 8-bit bitmap, i.e., b₇b₆b₅b₄b₃b₂b₁b₀, shall be indicated by the TPMI field in the scheduling DCI to indicate the precoding matrix for the scheduling PUSCH, where bᵢ indicates whether antenna port pᵢ=1000+i is selected for the PUSCH transmission, i.e., bᵢ=1 indicates that antenna port pᵢ=1000+i is selected for the PUSCH transmission, while bᵢ=0 indicates that antenna port pᵢ=1000+i is not selected for the PUSCH transmission. The number of non-zero values (i.e., ‘1’) in the bitmap indicates the number of scheduled layers. The n^{th} scheduled PUSCH layer is transmitted by the n^{th} indicated antenna port 1000+i beginning from the smallest i of the non-zero bit bᵢ. The normalization factor is determined as

$$\frac{1}{2 \sqrt{2}} .$$

The precoding vector used for each antenna port can be predetermined as in Table 3.

TABLE 3
precoding vector used for each antenna port

| Antenna port | Precoding vector |
|---|---|
| 1000 | [1, 0, 0, 0, 0, 0, 0, 0]^{T} |
| 1001 | [0, 1, 0, 0, 0, 0, 0, 0]^{T} |
| 1002 | [0, 0, 1, 0, 0, 0, 0, 0]^{T} |
| 1003 | [0, 0, 0, 1, 0, 0, 0, 0]^{T} |
| 1004 | [0, 0, 0, 0, 1, 0, 0, 0]^{T} |
| 1005 | [0, 0, 0, 0, 0, 1, 0, 0]^{T} |
| 1006 | [0, 0, 0, 0, 0, 0, 1, 0]^{T} |
| 1007 | [0, 0, 0, 0, 0, 0, 0, 1]^{T} |

For example, if 00101010 is indicated by the TPMI field, a rank 3 PUSCH (i.e., with a first layer, a second layer and a third layer) is scheduled since there are three ‘1’s in the bitmap of 00101010. b₁, b₃, and b₅ being ‘1’ means that the n^{th} (n is from 1 to 3) indicated antenna port is antenna port 1001, antenna port 1003 and antenna port 1005, respectively. It means that the first layer is transmitted by antenna port 1001 (the first indicated antenna port by b₁=1); the second layer is transmitted by antenna port 1003 (the second indicated antenna port by b₃=1); and the third layer is transmitted by antenna port 1005 (the third indicated antenna port by b₅=1). So, the precoding matrix for the scheduled rank 3 PUSCH is determined as

$$\frac{1}{2 \sqrt{2}} [ \begin{matrix}0 & 0 & 0 \\ 1 & 0 & 0 \\ 0 & 0 & 0 \\ 0 & 1 & 0 \\ 0 & 0 & 0 \\ 0 & 0 & 1 \\ 0 & 0 & 0 \\ 0 & 0 & 0\end{matrix} ] .$$

Considering that UE with eight antenna ports can have three different UE capabilities corresponding to maxRank=1, maxRank=4 and maxRank=8, the TPMI indication for maxRank=1 can have an alternative manner with less TPMI field overhead.

In particular, For the UE with maxRank=1, a 3-bit TPMI field can be used for indicating precoding matrix with interpretation as illustrated in Table 4:

TABLE 4
TPMI field interpretation for non-coherent UE with maxRank = 1

| TPMI field value | Precoding matrix |
|---|---|
| 000 | $\frac{1}{2 \sqrt{2}} \times {[ 1 , 0 , 0 , 0 , 0 , 0 , 0 , 0 ]}^{T}$ |
| 001 | $\frac{1}{2 \sqrt{2}} \times {[ 0 , 1 , 0 , 0 , 0 , 0 , 0 , 0 ]}^{T}$ |
| 010 | $\frac{1}{2 \sqrt{2}} \times {[ 0 , 0 , 1 , 0 , 0 , 0 , 0 , 0 ]}^{T}$ |
| 011 | $\frac{1}{2 \sqrt{2}} \times {[ 0 , 0 , 0 , 1 , 0 , 0 , 0 , 0 ]}^{T}$ |
| 100 | $\frac{1}{2 \sqrt{2}} \times {[ 0 , 0 , 0 , 0 , 1 , 0 , 0 , 0 ]}^{T}$ |
| 101 | $\frac{1}{2 \sqrt{2}} \times {[ 0 , 0 , 0 , 0 , 0 , 1 , 0 , 0 ]}^{T}$ |
| 110 | $\frac{1}{2 \sqrt{2}} \times {[ 0 , 0 , 0 , 0 , 0 , 0 , 1 , 0 ]}^{T}$ |
| 111 | $\frac{1}{2 \sqrt{2}} \times {[ 0 , 0 , 0 , 0 , 0 , 0 , 0 , 1 ]}^{T}$ |

A second embodiment relates to precoder for full-coherent UE (i.e., UE with Ng=1).

The codebook structure for each rank is introduced. Parameterized codebook is designed for full coherent UE with the following parameters.

M is the number of antennas in horizontal.

N is the number of antennas in vertical.

Oₘ is oversample factor for the horizontal DFT vector.

Oₙ is oversample factor for the vertical DFT vector.

$${u}_{m} = ( \begin{matrix}1 & {e}^{j \frac{2 π m}{{o}_{m} M}} & … & {e}^{j \frac{2 π m ( M - 1 )}{{o}_{m} M}} )\end{matrix}$$

is a oversampled DFT vector in horizontal.

$${v}_{n} = ( \begin{matrix}1 & {e}^{j \frac{2 π n}{{o}_{n} N}} & … & {e}^{j \frac{2 π n ( N - 1 )}{{o}_{n} N}} )\end{matrix}$$

is a oversampled DFT vector in vertical.

The larger oversample factor (uₘ and/or vₙ) has better system performance but leads larger TPMI field overhead.

The following supported pairs of (Oₘ, Oₙ) for different antenna layouts (M, N) are proposed in Table 5.

TABLE 5
supported pairs of (Oₘ, Oₙ) for each antenna layout (M, N)

| antenna layout (M, N) | Supported pairs of (Oₘ, Oₙ) |
|---|---|
| (2, 2) | (1, 1), (2, 2), (4, 4), (2, 1), (4, 1), (4, 2), (2, 4) |
| (4, 1) | (1, 1), (2, 1), (4, 1) |

The UE with Ng=1 shall report the antenna layout, i.e., a pair of (M, N). For example, the pair of (M, N) can be (2, 2) or (4, 1).

The UE may support one or multiple pairs of (Oₘ, Oₙ) for an antenna layout, i.e., for a pair of (M, N). If only one pair of (Oₘ, Oₙ) for one antenna layout (M, N) is specified (or predetermined), there is no need to report the one pair of (Oₘ, Oₙ) by the UE. Otherwise, the UE shall report one or multiple supported pairs of (Oₘ, Oₙ) when reporting the parameter (M, N) for the antenna layout. If the UE reports multiple supported pairs of (Oₘ, Oₙ) for one antenna layout (M, N), the gNB shall further configure one of the supported pairs of (Oₘ, Oₙ) for the one antenna layout (M, N) to the UE.

As a whole, a pair of (Oₘ, Oₙ) (the predetermined pair of (Oₘ, Oₙ), or the reported one pair of (Oₘ, Oₙ), or the configured one pair of (Oₘ, Oₙ) from the reported pairs of (Oₘ, Oₙ)) for the pair of (M, N) are determined for the UE with Ng=1, so that the UE can obtain the correct precoding matrix.

A first sub-embodiment of the second embodiment relates precoder for rank=1 (rank 1 precoder W_{8Tx,1}).

The rank 1 precoder where

$${w}_{8 Tx , 1} = \frac{1}{\sqrt{2 MN}} \times [ \begin{matrix}{b}_{m , n} \\ {φ}_{p} {b}_{m , n}\end{matrix} ] ,$$

b_{m,n} is a oversampled 2D DFT vector with a length of M×N,

$${b}_{m , n} = vec ( {u}_{m} ⊗ {v}_{n} ) = {( \begin{matrix}{u}_{m} & {e}^{j \frac{2 π n}{{o}_{n} N}} {u}_{m} & ⋯ & {e}^{j \frac{2 π {k}_{2} ( N - 1 )}{{o}_{n} N}} {u}_{m}\end{matrix} )}^{T} ,$$

$${u}_{m} = ( \begin{matrix}1 & {e}^{j \frac{2 π m}{{o}_{m} M}} & ⋯ & {e}^{j \frac{2 π m ( M - 1 )}{{o}_{m} M}} ) ,\end{matrix} {v}_{n} = ( \begin{matrix}1 & {e}^{j \frac{2 π n}{{o}_{n} N}} & ⋯ & {e}^{j \frac{2 π n ( N - 1 )}{{o}_{n} N}} ) ,\end{matrix}$$

φₗ=e^{jπn/2}∈{1, j, −1, −j} is the co-phasing coefficient between two polarizations.

m∈{0, 1, . . . , MOₘ−1}, n∈{0,1, . . . , NOₙ−1}, l∈{0,1,2,3}.

For the UE to obtain the final rank 1 precoder W_{8Tx,1}, m, n, and l should be indicated.

A second sub-embodiment of the second embodiment relates precoder for rank=2 (rank 2 precoder W_{8Tx,2}).

The rank 2 precoder

$${W}_{8 Tx , 2} = \frac{1}{\sqrt{4 MN}} \times [ \begin{matrix}{b}_{m , n} & {b}_{{m}^{′} , {n}^{′}} \\ {φ}_{l} {b}_{m , n} & - {φ}_{l} {b}_{{m}^{′} , {n}^{′}}\end{matrix} ] ,$$

where

$${m}^{′} = m + Δ m , {n}^{′} = n + Δ n ,$$

m∈{0, 1, . . . , MOₘ−1}, n∈{0,1, . . . , NOₙ−1}, l∈{0,2},
for (M, N)=(2, 2), (Δm, Δn)∈{(0,0), (Oₘ, 0), (0, Oₙ), (Oₘ, Oₙ)},
for (M, N)=(4, 1), (Δm, Δn)∈{(0,0), (Oₘ, 0), (2Oₘ, 0), (3Oₘ, 0)}.

For the UE to obtain the final rank 2 precoder W_{8Tx,2}, m, n, (Δm, Δn), and l should be indicated.

A third sub-embodiment of the second embodiment relates precoder for rank=3 (rank 3 precoder W_{8Tx,3})

The rank 3 precoder

$${W}_{8 Tx , 3} = \frac{1}{\sqrt{6 MN}} \times [ \begin{matrix}{b}_{m , n} & {b}_{{m}^{′} , {n}^{′}} & {b}_{m , n} \\ {φ}_{l} {b}_{m , n} & {φ}_{l} {b}_{{m}^{′} , {n}^{′}} & - {φ}_{l} {b}_{m , n}\end{matrix} ] ,$$

where
m∈{0, 1, . . . , MOₘ−1}, n∈{0,1, . . . , NOₙ−1}, l∈{0,2},

$${m}^{′} = m + Δ m , {n}^{′} = n + Δ n ,$$

for (M, N)=(2, 2), (Δm, Δn)∈{(Oₘ, 0), (0, Oₙ), (Oₘ, Oₙ)},
for (M, N)=(4, 1), (Δm, Δn)∈{(Oₘ, 0), (2Oₘ, 0), (3Oₘ, 0)}.

For the UE to obtain the final rank 3 precoder W_{8Tx,3}, m, n, (Δm, Δn), and/should be indicated.

A fourth sub-embodiment of the second embodiment relates precoder for rank=4 (rank 4 precoder W_{8Tx,4}).

The rank 4 precoder

$${W}_{8 Tx , 4} = \frac{1}{\sqrt{8 MN}} \times [ \begin{matrix}{b}_{m , n} & {b}_{{m}^{′} , {n}^{′}} & {b}_{m , n} & {b}_{{m}^{′} , {n}^{′}} \\ {φ}_{l} {b}_{m , n} & {φ}_{l} {b}_{{m}^{′} , {n}^{′}} & - {φ}_{l} {b}_{m , n} & - {φ}_{l} {b}_{{m}^{′} , {n}^{′}}\end{matrix} ] ,$$

where
m∈{0, 1, . . . , MOₘ−1}, n∈{0,1, . . . , NOₙ−1}, l∈{0,2},

$${m}^{′} = m + Δ m , {n}^{′} = n + Δ n ,$$

for (M, N)=(2, 2), (Δm, Δn)∈{(Oₘ, 0), (0, Oₙ), (Oₘ, Oₙ)},
for (M, N)=(4, 1), (Δm, Δn)∈{(Oₘ, 0), (2Oₘ, 0), (3Oₘ, 0)}.

For the UE to obtain the final rank 4 precoder W_{8Tx,4}, m, n, (Δm, Δn), and/should be indicated.

A fifth embodiment of the second embodiment relates precoder for rank=5 (rank 5 precoder W_{8Tx,5}).

The rank 5 precoder

$${W}_{8 Tx , 5} = \frac{1}{\sqrt{10 MN}} \times [ \begin{matrix}{b}_{m , n} & {b}_{m , n} & {b}_{{m}^{′} , {n}^{′}} & {b}_{{m}^{′} , {n}^{′}} & {b}_{{m}^{″} , {n}^{″}} \\ {φ}_{l} {b}_{m , n} & - {φ}_{l} {b}_{m , n} & {b}_{{m}^{′} , {n}^{′}} & - {b}_{{m}^{′} , {n}^{′}} & {b}_{{m}^{″} , {n}^{″}}\end{matrix} ] ,$$

where
m∈{0, 1, . . . , MOₘ−1}, n∈{0,1, . . . , NOₙ−1}, l∈{0,2},

$${m}^{′} = m + Δ m , {n}^{′} = n + Δ n ,$$

$${m}^{″} = m + Δ {m}^{′} , {n}^{″} = n + Δ {n}^{′} ,$$

for (M, N)=(2, 2), (Δm, Δn)=(Oₘ, 0), (Δm′, Δn′)=(Oₘ, Oₙ),
for (M, N)=(4, 1), (Δm, Δn)=(Oₘ, 0), (Δm′, Δn′)=(2Oₘ, 0).

For the UE to obtain the final rank 5 precoder W_{8Tx,5}, m, n, and l should be indicated.

A sixth embodiment of the second embodiment relates precoder for rank=6 (rank 6 precoder W_{8Tx,6}).

The rank 6 precoder

$${W}_{8 Tx , 6} = \frac{1}{\sqrt{12 MN}} \times [ \begin{matrix}{b}_{m , n} & {b}_{m , n} & {b}_{{m}^{′} , {n}^{′}} & {b}_{{m}^{′} , {n}^{′}} & {b}_{{m}^{″} , {n}^{″}} & {b}_{{m}^{″} , {n}^{″}} \\ {φ}_{l} {b}_{m , n} & - {φ}_{l} {b}_{m , n} & {φ}_{l} {b}_{{m}^{′} , {n}^{′}} & - {ϕ}_{l} {b}_{{m}^{′} , {n}^{′}} & {b}_{{m}^{″} , {n}^{″}} & - {b}_{{m}^{″} , {n}^{″}}\end{matrix} ] ,$$

where
m∈{0, 1, . . . , MOₘ−1}, n∈{0,1, . . . , NOₙ−1}, l∈{0,2},

$${m}^{′} = m + Δ m , {n}^{′} = n + Δ n ,$$

$${m}^{″} = m + Δ {m}^{′} , {n}^{″} = n + Δ {n}^{′} ,$$

for (M, N)=(2, 2), (Δm, Δn)=(Oₘ, 0), (Δm′, Δn′)=(Oₘ, Oₙ),
for (M, N)=(4, 1), (Δm, Δn)=(Oₘ, 0), (Δm′, Δn′)=(2Oₘ, 0).

For the UE to obtain the final rank 6 precoder W_{8Tx,6}, m, n, and l should be indicated.

A seventh embodiment of the second embodiment relates precoder for rank=7 (rank 7 precoder W_{8Tx,7}).

The rank 7 precoder

$${W}_{8 Tx , 7} = \frac{1}{\sqrt{14 MN}} \times [ \begin{matrix}{b}_{m , n} & {b}_{m , n} & {b}_{{m}^{′} , {n}^{′}} & {b}_{{m}^{″} , {n}^{″}} & {b}_{{m}^{″} , {n}^{″}} & {b}_{{m}^{′′′} , {n}^{′′′}} & {b}_{{m}^{′′′} , {n}^{′′′}} \\ {φ}_{l} {b}_{m , n} & - {φ}_{l} {b}_{m , n} & {φ}_{l} {b}_{{m}^{′} , {n}^{′}} & {b}_{{m}^{″} , {n}^{″}} & - {b}_{{m}^{″} , {n}^{″}} & {b}_{{m}^{′′′} , {n}^{′′′}} & - {b}_{{m}^{′′′} , {n}^{′′′}}\end{matrix} ] ,$$

where

$${m}^{′} = m + Δ m , {n}^{′} = n + Δ n ,$$

$${m}^{″} = m + Δ {m}^{′} , {n}^{″} = n + Δ {n}^{′} ,$$

$${m}^{′′′} = m + Δ {m}^{″} , {n}^{′′′} = n + Δ {n}^{″} ,$$

for (M, N)=(2, 2), m∈{0, 1, . . . , MOₘ−1}, n∈{0,1, . . . , NOₙ−1}, l∈{0,2}, (Δm, Δn)=(Oₘ, 0), (Δm′, Δn′)=(0, Oₙ), (Δm″, Δn″)=(Oₘ, Oₙ),
for (M, N)=(4, 1), m∈

$$\{ 0 , 1 , … , \frac{M {O}_{m}}{2} - 1 \} ,$$

n∈{0,1, . . . , NOₙ−1}, l∈{0,2}, (Δm, Δn)=(Oₘ, 0), (Δm′, Δn′)=(2Oₘ, 0), (Δm″, Δn″)=(3Oₘ, 0).

For the UE to obtain the final rank 7 precoder W_{8Tx,7}, m, n, and l should be indicated.

An eighth embodiment of the second embodiment relates precoder for rank=8 (rank 8 precoder W_{8Tx,8}).

The rank 8 precoder

$${W}_{8 Tx , 8} = \frac{1}{\sqrt{16 MN}} \times [ \begin{matrix}{b}_{m , n} & {b}_{m , n} & {b}_{{m}^{′} , {n}^{′}} & {b}_{{m}^{′} , {n}^{′}} & {b}_{{m}^{″} , {n}^{″}} & {b}_{{m}^{″} , {n}^{″}} & {b}_{{m}^{′′′} , {n}^{′′′}} & {b}_{{m}^{′′′} , {n}^{′′′}} \\ {φ}_{l} {b}_{m , n} & - {φ}_{l} {b}_{m , n} & {ϕ}_{l} {b}_{{m}^{′} , {n}^{′}} & - {ϕ}_{l} {b}_{{m}^{′} , {n}^{′}} & {b}_{{m}^{″} , {n}^{″}} & - {b}_{{m}^{″} , {n}^{″}} & {b}_{{m}^{′′′} , {n}^{′′′}} & - {b}_{{m}^{′′′} , {n}^{′′′}}\end{matrix} ] ,$$

where

$${m}^{′} = m + Δ m , {n}^{′} = n + Δ n ,$$

$${m}^{″} = m + Δ {m}^{′} , {n}^{″} = n + Δ {n}^{′} ,$$

$${m}^{′′′} = m + Δ {m}^{″} , {n}^{′′′} = n + Δ {n}^{″} ,$$

for (M, N)=(2, 2), m∈{0, 1, . . . , MOₘ−1}, n∈{0,1, . . . , NOₙ−1}, l∈{0,2}, (Δm, Δn)=(Oₘ, 0), (Δm′, Δn′)=(0, Oₙ), (Δm″, Δn″)=(Oₘ, Oₙ),
for (M, N)=(4, 1),

$$m ∈ \{ 0 , 1 , … , \frac{{MO}_{m}}{2} - 1 \} ,$$

n∈{0,1, . . . , NOₙ−1}, l∈{0,2}, (Δm, Δn)=(Oₘ, 0), (Δm′, Δn′)=(2Oₘ, 0), (Δm″, Δn″)=(3Oₘ, 0).

For the UE to obtain the final rank 8 precoder W_{8Tx,8}, m, n, and l should be indicated.

A third embodiment relates to TPMI indication for full-coherent UE (i.e., UE with Ng=1).

In NR Release 15, full coherent UE shall support all the full-coherent, partial-coherent, and non-coherent precoding matrices with capability fullyAndPartialAndNonCoherent. The motivation of supporting all the full-coherent, partial-coherent, and non-coherent precoding matrices is that the gNB can schedule PUSCH transmitted by part of antenna port(s) (instead of all antenna ports) for power saving. However, advanced UEs with eight antenna ports target the high power device including CPE, FWA, vehicle, and industrial devices. For the high power device, power may not be an issue. In addition, full-coherent only precoding scheme corresponds to small standard effort and limited UE complexity. Accordingly, this disclosure proposes that NR Release 18 UE with eight antenna ports can report its capability as only support of full-coherent precoders.

The precoding matrix structure along with the antenna layout parameters are discussed in the second embodiment. For the PUSCH transmission scheduled by a DCI, the DCI shall indicate the parameters including at least m, n, l for the UE to obtain or construct the precoding matrix for the scheduled PUSCH transmission.

It is assumed that the transmission rank is separately indicated or determined by antenna port(s) field of the scheduling DCI, which is used to indicate the DMRS port(s) for the scheduled PUSCH transmission. The transmission rank is exactly the same as the number of indicated DMRS ports for the scheduled PUSCH transmission. DMRS is used for channel estimation for PUSCH demodulation.

So, the TPMI field only needs to indicate the parameters for the UE to obtain the precoding matrix (or precoder) W_{8Tx,i} (where i is from 1 to 8).

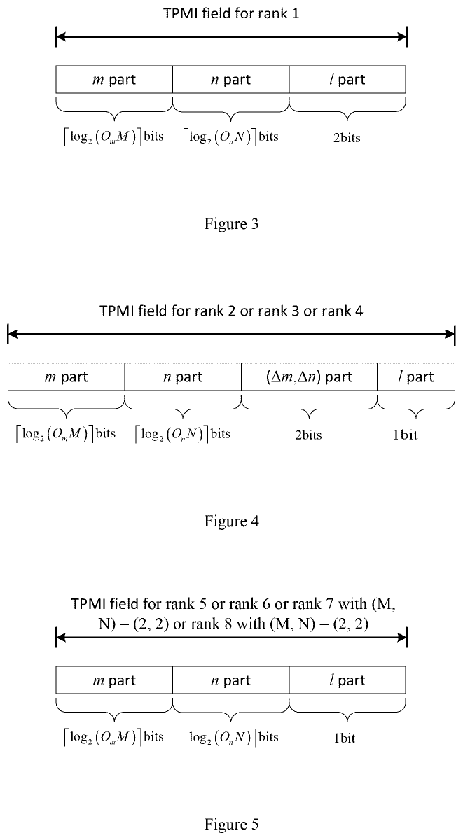

The TPMI field for rank 1 includes the following contents illustrated in FIG. 3: m part with ┌log₂(M×Oₘ)┐ bits to indicate m with M×Oₘ candidate values; n part with ┌log₂(N×Oₙ)┐ bits to indicate n with N×Oₙ candidate values; and/part with 2 bits to indicate l with 4 candidate values.

The TPMI field for rank 2 or rank 3 or rank 4 includes the following contents illustrated in FIG. 4: m part with ┌log₂(M×Oₘ)┐ bits to indicate m with M×Oₘ candidate values; n part with ┌log₂(N×Oₙ)┐ bits to indicate n with N×Oₙ candidate values; (Δm, Δn) part with 2 bits to indicate (Δm, Δn) with 4 candidate values (for rank=2) or 3 candidate values (for rank=3 or 4), and l part with 1 bit to indicate l with 2 candidate values.

The TPMI field for rank 5 or rank 6 or rank 7 with (M, N)=(2, 2) or rank 8 with (M, N)=(2, 2) includes the following contents illustrated in FIG. 5: m part with ┌log₂(M×Oₘ)┐ bits to indicate m with M×Oₘ candidate values; n part with ┌log₂(N×Oₙ)┐ bits to indicate n with N×Oₙ candidate values; and/part with 1 bit to indicate l with 2 candidate values.

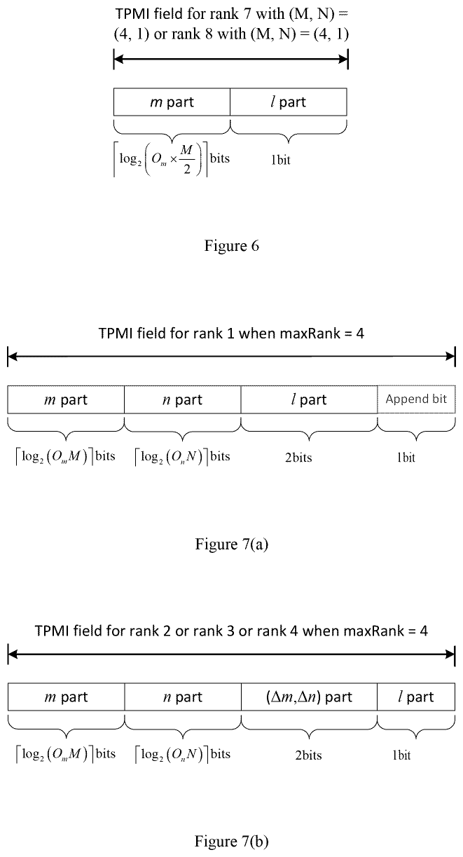

The TPMI field for rank 7 with (M, N)=(4, 1) or rank 8 with (M, N)=(4, 1) includes the following contents illustrated in FIG. 6: m part with

$$⌈ {log}_{2} ( \frac{M \times {O}_{m}}{2} ) ⌉$$

bits to indicate m with

$$\frac{M \times {O}_{m}}{2}$$

candidate values, and l part with 1 bit to indicate l with 2 candidate values. The n part is not necessary because when (M, N)=(4, 1), Oₙ can only be 1 (see Table 5). It means that N×Oₙ=1. Accordingly, n has only one candidate value of 0. From another point of view, ┌log₂(N×Oₙ)┐=┌log₂(1×1)┐=0.

As mentioned above, a UE with eight antenna ports can have three different UE capabilities corresponding to maxRank=1, maxRank=4 and maxRank=8. So, different maxRanks may correspond to different bitwidths of the TPMI field.

For maxRank=1, the candidate rank of the scheduled PUSCH can only be 1. So, the bitwidth of TPMI field for maxRank=1 is (┌log₂(OₘM)┐+┌log₂(OₙN)┐+2) bits (as shown in FIG. 3.

For maxRank=4, the candidate rank of the scheduled PUSCH can be 1, 2, 3 and 4. So, the bitwidth of TPMI field for maxRank=4 shall be the largest bitwidth for rank 1, rank 2, rank 3 and rank 4, which is the bitwidth for rank 2 or rank 3 or rank 4, i.e., (┌log₂(OₘM)┐+┌log₂(OₙN)┐+2+1) bits. The reason to have a same TPMI field length for different allowed ranks is to reduce the DCI blind decode complexity. In addition, when a rank 1 PUSCH is scheduled, ‘append bit’ (with 1 bit) is necessary for the TPMI field of the scheduling DCI. FIG. 7(a) illustrates the TPMI field for the scheduled rank 1 PUSCH when maxRank=4; and FIG. 7(b) illustrates the TPMI field for the scheduled rank 2 or rank 3 or rank 4 PUSCH when maxRank=4.

For maxRank=8, the candidate rank of the scheduled PUSCH can be 1, 2, 3, 4, 5, 6, 7 and 8. So, the bitwidth of TPMI field for maxRank=8 shall be the largest bitwidth for rank 1, rank 2, rank 3, rank 4, rank 5, rank 6, rank 7 and rank 8, which is the bitwidth for rank 2 or rank 3 or rank 4, i.e., (┌log₂(OₘM)┐+┌log₂(OₙN)┐+2+1) bits. In addition, when rank 1 PUSCH transmission is scheduled, ‘append bit’ (with 1 bit) is necessary for the TPMI field of the scheduling DCI. When a PUSCH with rank 5 or rank 6 or rank 7 with (M, N)=(2, 2) or rank 8 with (M, N)=(2, 2) is scheduled, ‘append bit’ (with 2 bits) is necessary for the TPMI field of the scheduling DCI. When a PUSCH with rank 7 with (M, N)=(4, 1) or rank 8 with (M, N)=(4, 1) is scheduled, ‘append bit’

$$( with x = ( ⌈ {log}_{2} ( {O}_{m} M ) ⌉ + ⌈ {log}_{2} ( {O}_{n} N ) ⌉ + 2 - ⌈ {log}_{2} ( {O}_{m} \times \frac{M}{2} ) ⌉ ) bits )$$

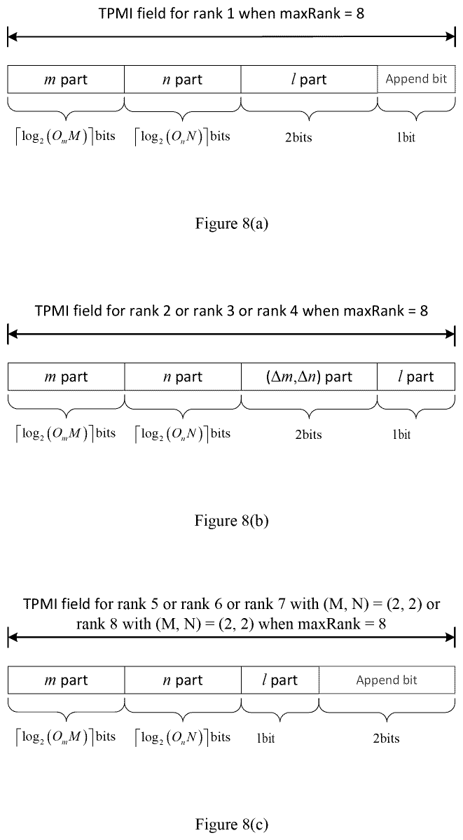

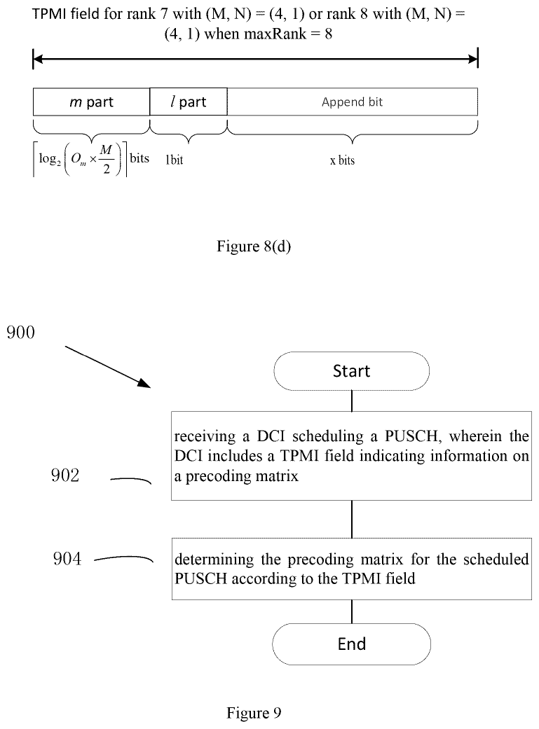

is necessary for the TPMI field of the scheduling DCI. FIG. 8(a) illustrates the TPMI field for the scheduled rank 1 PUSCH when maxRank=8: FIG. 8(b) illustrates the TPMI field for the scheduled rank 2 or rank 3 or rank 4 PUSCH when maxRank=8: FIG. 8(c) illustrates the TPMI field for the scheduled rank 5 or rank 6 or rank 7 with (M, N)=(2, 2) or rank 8 with (M, N)=(2, 2) PUSCH when maxRank=8; and FIG. 8(d) illustrates the TPMI field for the scheduled rank 7 with (M, N)=(4, 1) or rank 8 with (M, N)=(4, 1) PUSCH when maxRank=8.

It can be seen that the “append bit” part is necessary so that the TPMI field has the same bitwidth for each maxRank with the same pair of (M, N) and the same pair of (Oₘ, Oₙ).

An example of the third embodiment is as follows:

A UE reports its antenna layout (M, N)=(4, 1) (e.g., (M, N, P)=(4, 1, 2)). The UE only supports full-coherent precoding with maxRank=8. In addition, the UE only supports (Oₘ, Oₙ)=(4, 1). Accordingly, the bit width of the TPMI field is ┌log₂(OₘM)┐+┌log₂(OₙN)┐+2+1)=(┌log₂(4×4)┐+┌log₂(1×1)┐+2+1)=4+0+2+1=7 bits.

When the UE receives a DCI scheduling a PUSCH transmission with rank 1, the first 4 bits of TPMI field indicates the value of m, and n=0. The next 2 bits (after the first 4 bits) of the TPMI field indicates the value of l. The last 1 bit of the TPMI field is append bit.

When the UE receives a DCI scheduling a PUSCH transmission with rank 4, the first 4 bits of TPMI field indicates the value of m, and n=0. The next 2 bits (after the first 4 bits) of the TPMI field indicates the value of Δm and Δn, and the last 1 bit of the TPMI field indicates the value of l.

When the UE receives a DCI scheduling a PUSCH transmission with 7, the first

$$⌈ {log}_{2} ( {O}_{m} \times \frac{M}{2} ) ⌉ = ⌈ {log}_{2} ( 4 \times \frac{4}{2} ) ⌉ = 3$$

bits of TPMI field indicates the value of m, and n=0, and the next 1 bit (after the first 3 bits) of TPMI field indicates the value of l. The last 3 bits of the TPMI field are append bit.

FIG. 9 is a schematic flow chart diagram illustrating an embodiment of a method 900 according to the present application. In some embodiments, the method 900 is performed by an apparatus, such as a remote unit (e.g., UE). In certain embodiments, the method 900 may be performed by a processor executing program code, for example, a microcontroller, a microprocessor, a CPU, a GPU, an auxiliary processing unit, a FPGA, or the like.

The method 900 is a method performed at a UE, comprising: 902 receiving a DCI scheduling a PUSCH, wherein the DCI includes a TPMI field indicating information on a precoding matrix; and 904 determining the precoding matrix for the scheduled PUSCH according to the TPMI field.

In some embodiment, the method further comprises reporting the number of antenna groups (Ng).

In some embodiment, if the number of antenna groups (Ng) is 8 for the UE, the TPMI field contains a 8-bit bitmap b₇b₆b₅b₄b₃b₂b₁b₀, where, the number of non-zero bits in the 8-bit bitmap indicates the number of PUSCH layers of the scheduled PUSCH, each non-zero bit bᵢ indicates that antenna port 1000+i is used for PUSCH transmission, where i is from 0 to 7, and the n^{th} PUSCH layer of the scheduled PUSCH is transmitted by the n^{th} indicated antenna port 1000+i beginning from the smallest i of the non-zero bit bᵢ.

In some embodiment, if the number of antenna groups (Ng) is 1 for the UE, the DCI further includes an antenna port(s) field indicating the number of DMRS ports that determines a rank of the scheduled PUSCH, and the precoding matrix for the scheduled PUSCH is determined according to the rank and the TPMI field, and the method further comprises reporting the supported pairs of oversampling factors (Oₘ, Oₙ) in horizontal and vertical corresponding to the reported (M, N). If more than one pair of oversampling factors (Oₘ, Oₙ) is reported, the method further comprises receiving a configuration to configure a pair of oversampling factors (Oₘ, Oₙ).

In some embodiment, if the number of antenna groups (Ng) is 1 for the UE and the UE only supports full-coherent precoding, the bitwidth of TPMI field is (┌log₂(OₘM)┐+┌log₂(OₙN)┐+2) bits for maxRank=1; and the bitwidth of TPMI field is (┌log₂(OₘM)┐+┌log₂(OₙN)┐+2+1) bits for maxRank=4 or 8. In particular, if the transmit rank of the scheduled PUSCH is 1, a m value, a n value and a l value are used for obtaining the precoding matrix for the scheduled PUSCH, and in the TPMI field, first ┌log₂(OₘM)┐ bit(s) indicate the m value, ┌log₂(OₙN)┐ bit(s) following the ┌log₂(OₘM)┐ bit(s) indicate the n value, and two bits following the ┌log₂(OₙN)┐ bit(s) indicate the l value. If the transmit rank of the scheduled PUSCH is 2 or 3 or 4, a m value, a n value, a pair of (Δm, Δn) value and a l value are used for obtaining the precoding matrix for the scheduled PUSCH, and in the TPMI field, first ┌log₂(OₘM)┐ bit(s) indicate the m value, ┌log₂(OₙN)┐ bit(s) following the ┌log₂(OₘM)┐ bit(s) indicate the n value, two bits following the ┌log₂(OₙN)┐ bit(s) indicate the pair of (Δm, Δn) value, and the last one bit indicates the l value. If the transmit rank of the scheduled PUSCH is 5 or 6, a m value, a n value, a pair of (Δm, Δn) value and a l value are used for obtaining the precoding matrix for the scheduled PUSCH, and in the TPMI field, first ┌log₂(OₘM)┐ bit(s) indicate the m value, ┌log₂(OₙN)┐ bit(s) following the ┌log₂(OₘM)┐ bit(s) indicate the n value, and one bit following the ┌log₂(OₙN)┐ bit(s) indicates the l value, where, the pair of (Δm, Δn) value is predetermined. If the transmit rank of the scheduled PUSCH is 7 or 8 and the pair of (M, N) is (2, 2), a m value, a n value, a pair of (Δm, Δn) value and a l value are used for obtaining the precoding matrix for the scheduled PUSCH, and in the TPMI field, first ┌log₂(OₘM)┐ bit(s) indicate the m value, ┌log₂(OₙN)┐ bit(s) following the ┌log₂(OₘM)┐ bit(s) indicate the n value, and one bit following the ┌log₂(OₙN)┐ bit(s) indicates the l value, where, the pair of (Δm, Δn) value is predetermined. If the transmit rank of the scheduled PUSCH is 7 or 8 and the pair of (M, N) is (4, 1), a m value, a n value, a pair of (Δm, Δn) value and a l value are used for obtaining the precoding matrix for the scheduled PUSCH, and in the TPMI field, first

$$⌈ {log}_{2} ( \frac{{O}_{m} M}{2} ) ⌉$$

bit(s) indicate the m value, and one bit following the

$$⌈ {log}_{2} ( \frac{{O}_{m} M}{2} ) ⌉$$

bit(s) indicates the l value, where, the n value is predetermined, and the pair of (Δm, Δn) value is predetermined.

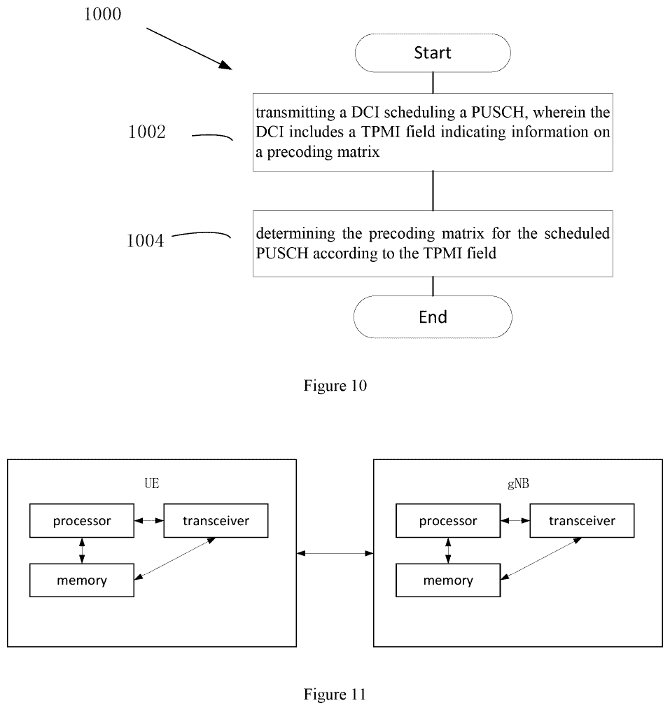

FIG. 10 is a schematic flow chart diagram illustrating an embodiment of a method 1000 according to the present application. In some embodiments, the method 1000 is performed by an apparatus, such as a base unit. In certain embodiments, the method 1000 may be performed by a processor executing program code, for example, a microcontroller, a microprocessor, a CPU, a GPU, an auxiliary processing unit, a FPGA, or the like.

The method 1000 may comprise 1002 transmitting a DCI scheduling a PUSCH, wherein the DCI includes a TPMI field indicating information on a precoding matrix; and 1004 determining the precoding matrix for the scheduled PUSCH according to the TPMI field.

In some embodiment, the method further comprises receiving the number of antenna groups (Ng).

In some embodiment, if the number of antenna groups (Ng) is 8 for the UE, the TPMI field contains a 8-bit bitmap b₇b₆b₅b₄b₃b₂b₁b₀, where, the number of non-zero bits in the 8-bit bitmap indicates the number of PUSCH layers of the scheduled PUSCH, each non-zero bit bᵢ indicates that antenna port 1000+i is used for PUSCH transmission, where i is from 0 to 7, and the n^{th} PUSCH layer of the scheduled PUSCH is transmitted by the n^{th} indicated antenna port 1000+i beginning from the smallest i of the non-zero bit bᵢ.

In some embodiment, if the number of antenna groups (Ng) is 1 for the UE, the DCI further includes an antenna port(s) field indicating the number of DMRS ports that determines a rank of the scheduled PUSCH, and the precoding matrix for the scheduled PUSCH is determined according to the rank and the TPMI field, and the method further comprises receiving the supported pairs of oversampling factors (Oₘ, Oₙ) in horizontal and vertical corresponding to the reported (M, N). If more than one pair of oversampling factors (Oₘ, Oₙ) is receive, the method further comprises transmitting a configuration to configure a pair of oversampling factors (Oₘ, Oₙ).

In some embodiment, if the number of antenna groups (Ng) is 1 for the UE and the UE only supports full-coherent precoding, the bitwidth of TPMI field is (┌log₂(OₘM)┐+┌log₂(OₙN)┐+2) bits for maxRank=1; and the bitwidth of TPMI field is (┌log₂(OₘM)┐+┌log₂(OₙN)┐+2+1) bits for maxRank=4 or 8. In particular, if the transmit rank of the scheduled PUSCH is 1, a m value, a n value and a l value are used for obtaining the precoding matrix for the scheduled PUSCH, and in the TPMI field, first ┌log₂(OₘM)┐ bit(s) indicate the m value, ┌log₂(OₙN)┐ bit(s) following the ┌log₂(OₘM)┐ bit(s) indicate the n value, and two bits following the ┌log₂(OₙN)┐ bit(s) indicate the l value. If the transmit rank of the scheduled PUSCH is 2 or 3 or 4, a m value, a n value, a pair of (Δm, Δn) value and a l value are used for obtaining the precoding matrix for the scheduled PUSCH, and in the TPMI field, first ┌log₂(OₘM)┐ bit(s) indicate the m value, ┌log₂(OₙN)┐ bit(s) following the ┌log₂(OₘM)┐ bit(s) indicate the n value, two bits following the ┌log₂(OₙN)┐ bit(s) indicate the pair of (Δm, Δn) value, and the last one bit indicates the l value. If the transmit rank of the scheduled PUSCH is 5 or 6, a m value, a n value, a pair of (Δm, Δn) value and a l value are used for obtaining the precoding matrix for the scheduled PUSCH, and in the TPMI field, first ┌log₂(OₘM)┐ bit(s) indicate the m value, ┌log₂(OₙN)┐ bit(s) following the ┌log₂(OₘM)┐ bit(s) indicate the n value, and one bit following the ┌log₂(OₙN)┐ bit(s) indicates the l value, where, the pair of (Δm, Δn) value is predetermined. If the transmit rank of the scheduled PUSCH is 7 or 8 and the pair of (M, N) is (2, 2), a m value, a n value, a pair of (Δm, Δn) value and a l value are used for obtaining the precoding matrix for the scheduled PUSCH, and in the TPMI field, first ┌log₂(OₘM)┐ bit(s) indicate the m value, ┌log₂(OₙN)┐ bit(s) following the ┌log₂(OₘM)┐ bit(s) indicate the n value, and one bit following the ┌log₂(OₙN)┐ bit(s) indicates the l value, where, the pair of (Δm, Δn) value is predetermined. If the transmit rank of the scheduled PUSCH is 7 or 8 and the pair of (M, N) is (4, 1), a m value, a n value, a pair of (Δm, Δn) value and a l value are used for obtaining the precoding matrix for the scheduled PUSCH, and in the TPMI field, first

$$⌈ {log}_{2} ( \frac{{O}_{m} M}{2} ) ⌉$$

bit(s) indicate the m value, and one bit following the

$$⌈ {log}_{2} ( \frac{{O}_{m} M}{2} ) ⌉$$

bit(s) indicates the l value, where, the n value is predetermined, and the pair of (Δm, Δn) value is predetermined.

FIG. 11 is a schematic block diagram illustrating apparatuses according to one embodiment.

Referring to FIG. 11, the UE (i.e., the remote unit) includes a processor, a memory, and a transceiver. The processor implements a function, a process, and/or a method which are proposed in FIG. 9.

The UE comprises a transceiver; and a processor coupled to the transceiver, wherein the processor is configured to receive, via the transceiver, a DCI scheduling a PUSCH, wherein the DCI includes a TPMI field indicating information on a precoding matrix; and determine the precoding matrix for the scheduled PUSCH according to the TPMI field.

In some embodiment, the processor is further configured to report, via the transceiver, the number of antenna groups (Ng).

In some embodiment, if the number of antenna groups (Ng) is 8 for the UE, the TPMI field contains a 8-bit bitmap b₇b₆b₅b₄b₃b₂b₁b₀, where, the number of non-zero bits in the 8-bit bitmap indicates the number of PUSCH layers of the scheduled PUSCH, each non-zero bit bᵢ indicates that antenna port 1000+i is used for PUSCH transmission, where i is from 0 to 7, and the n^{th} PUSCH layer of the scheduled PUSCH is transmitted by the n^{th} indicated antenna port 1000+i beginning from the smallest i of the non-zero bit bᵢ.

In some embodiment, if the number of antenna groups (Ng) is 1 for the UE, the DCI further includes an antenna port(s) field indicating the number of DMRS ports that determines a rank of the scheduled PUSCH, and the precoding matrix for the scheduled PUSCH is determined according to the rank and the TPMI field, and the processor is further configured to report, via the transceiver, the supported pairs of oversampling factors (Oₘ, Oₙ) in horizontal and vertical corresponding to the reported (M, N). If more than one pair of oversampling factors (Oₘ, Oₙ) is reported, the processor is further configured to receive, via the transceiver, a configuration to configure a pair of oversampling factors (Oₘ, Oₙ).

In some embodiment, if the number of antenna groups (Ng) is 1 for the UE and the UE only supports full-coherent precoding, the bitwidth of TPMI field is (┌log₂(OₘM)┐+┌log₂(OₙN)┐+2) bits for maxRank=1; and the bitwidth of TPMI field is (┌log₂(OₘM)┐+┌log₂(OₙN)┐+2+1) bits for maxRank=4 or 8. In particular, if the transmit rank of the scheduled PUSCH is 1, a m value, a n value and a l value are used for obtaining the precoding matrix for the scheduled PUSCH, and in the TPMI field, first ┌log₂(OₘM)┐ bit(s) indicate the m value, ┌log₂(OₙN)┐ bit(s) following the ┌log₂(OₘM)┐ bit(s) indicate the n value, and two bits following the ┌log₂(OₙN)┐ bit(s) indicate the l value. If the transmit rank of the scheduled PUSCH is 2 or 3 or 4, a m value, a n value, a pair of (Δm, Δn) value and a l value are used for obtaining the precoding matrix for the scheduled PUSCH, and in the TPMI field, first ┌log₂(OₘM)┐ bit(s) indicate the m value, ┌log₂(OₙN)┐ bit(s) following the ┌log₂(OₘM)┐ bit(s) indicate the n value, two bits following the ┌log₂(OₙN)┐ bit(s) indicate the pair of (Δm, Δn) value, and the last one bit indicates the l value. If the transmit rank of the scheduled PUSCH is 5 or 6, a m value, a n value, a pair of (Δm, Δn) value and a l value are used for obtaining the precoding matrix for the scheduled PUSCH, and in the TPMI field, first ┌log₂(OₘM)┐ bit(s) indicate the m value, ┌log₂(OₙN)┐ bit(s) following the ┌log₂(OₘM)┐ bit(s) indicate the n value, and one bit following the ┌log₂(OₙN)┐ bit(s) indicates the l value, where, the pair of (Δm, Δn) value is predetermined. If the transmit rank of the scheduled PUSCH is 7 or 8 and the pair of (M, N) is (2, 2), a m value, a n value, a pair of (Δm, Δn) value and a l value are used for obtaining the precoding matrix for the scheduled PUSCH, and in the TPMI field, first ┌log₂(OₘM)┐ bit(s) indicate the m value, ┌log₂(OₙN)┐ bit(s) following the ┌log₂(OₘM)┐ bit(s) indicate the n value, and one bit following the ┌log₂(OₙN)┐ bit(s) indicates the l value, where, the pair of (Δm, Δn) value is predetermined. If the transmit rank of the scheduled PUSCH is 7 or 8 and the pair of (M, N) is (4, 1), a m value, a n value, a pair of (Δm, Δn) value and a l value are used for obtaining the precoding matrix for the scheduled PUSCH, and in the TPMI field, first

$$⌈ {log}_{2} ( \frac{{O}_{m} M}{2} ) ⌉$$

bit(s) indicate the m value, and one bit following the

$$⌈ {log}_{2} ( \frac{{O}_{m} M}{2} ) ⌉$$

bit(s) indicates the l value, where, the n value is predetermined, and the pair of (Δm, Δn) value is predetermined.

The gNB (i.e., the base unit) includes a processor, a memory, and a transceiver. The processor implements a function, a process, and/or a method which are proposed in FIG. 10.

The base unit comprises a transceiver; and a processor coupled to the transceiver, wherein the processor is configured to transmit, via the transceiver, a DCI scheduling a PUSCH, wherein the DCI includes a TPMI field indicating information on a precoding matrix; and determine the precoding matrix for the scheduled PUSCH according to the TPMI field.

In some embodiment, the processor is further configured to receive, via the transceiver, the number of antenna groups (Ng).

In some embodiment, if the number of antenna groups (Ng) is 8 for the UE, the TPMI field contains a 8-bit bitmap b₇b₆b₅b₄b₃b₂b₁b₀, where, the number of non-zero bits in the 8-bit bitmap indicates the number of PUSCH layers of the scheduled PUSCH, each non-zero bit bᵢ indicates that antenna port 1000+i is used for PUSCH transmission, where i is from 0 to 7, and the n^{th} PUSCH layer of the scheduled PUSCH is transmitted by the n^{th} indicated antenna port 1000+i beginning from the smallest i of the non-zero bit bᵢ.

In some embodiment, if the number of antenna groups (Ng) is 1 for the UE, the DCI further includes an antenna port(s) field indicating the number of DMRS ports that determines a rank of the scheduled PUSCH, and the precoding matrix for the scheduled PUSCH is determined according to the rank and the TPMI field, and the processor is further configured to receive, via the transceiver, the supported pairs of oversampling factors (Oₘ, Oₙ) in horizontal and vertical corresponding to the reported (M, N). If more than one pair of oversampling factors (Oₘ, Oₙ) is receive, the processor is further configured to transmit, via the transceiver, a configuration to configure a pair of oversampling factors (Oₘ, Oₙ).

In some embodiment, if the number of antenna groups (Ng) is 1 for the UE and the UE only supports full-coherent precoding, the bitwidth of TPMI field is (┌log₂(OₘM)┐+┌log₂(OₙN)┐+2) bits for maxRank=1; and the bitwidth of TPMI field is (┌log₂(OₘM)┐+┌log₂(OₙN)┐+2+1) bits for maxRank=4 or 8. In particular, if the transmit rank of the scheduled PUSCH is 1, a m value, a n value and a l value are used for obtaining the precoding matrix for the scheduled PUSCH, and in the TPMI field, first ┌log₂(OₘM)┐ bit(s) indicate the m value, ┌log₂(OₙN)┐ bit(s) following the ┌log₂(OₘM)┐ bit(s) indicate the n value, and two bits following the ┌log₂(OₙN)┐ bit(s) indicate the l value. If the transmit rank of the scheduled PUSCH is 2 or 3 or 4, a m value, a n value, a pair of (Δm, Δn) value and a l value are used for obtaining the precoding matrix for the scheduled PUSCH, and in the TPMI field, first ┌log₂(OₘM)┐ bit(s) indicate the m value, ┌log₂(OₙN)┐ bit(s) following the ┌log₂(OₘM)┐ bit(s) indicate the n value, two bits following the ┌log₂(OₙN)┐ bit(s) indicate the pair of (Δm, Δn) value, and the last one bit indicates the l value. If the transmit rank of the scheduled PUSCH is 5 or 6, a m value, a n value, a pair of (Δm, Δn) value and a l value are used for obtaining the precoding matrix for the scheduled PUSCH, and in the TPMI field, first ┌log₂(OₘM)┐ bit(s) indicate the m value, ┌log₂(OₙN)┐ bit(s) following the ┌log₂(OₘM)┐ bit(s) indicate the n value, and one bit following the ┌log₂(OₙN)┐ bit(s) indicates the l value, where, the pair of (Δm, Δn) value is predetermined. If the transmit rank of the scheduled PUSCH is 7 or 8 and the pair of (M, N) is (2, 2), a m value, a n value, a pair of (Δm, Δn) value and a l value are used for obtaining the precoding matrix for the scheduled PUSCH, and in the TPMI field, first ┌log₂(OₘM)┐ bit(s) indicate the m value, ┌log₂(OₙN)┐ bit(s) following the ┌log₂(OₘM)┐ bit(s) indicate the n value, and one bit following the ┌log₂(OₙN)┐ bit(s) indicates the l value, where, the pair of (Δm, Δn) value is predetermined. If the transmit rank of the scheduled PUSCH is 7 or 8 and the pair of (M, N) is (4, 1), a m value, a n value, a pair of (Δm, Δn) value and a l value are used for obtaining the precoding matrix for the scheduled PUSCH, and in the TPMI field, first

$$⌈ {log}_{2} ( \frac{{O}_{m} M}{2} ) ⌉$$

bit(s) indicate the m value, and one bit following the

$$⌈ {log}_{2} ( \frac{{O}_{m} M}{2} ) ⌉$$

bit(s) indicates the l value, where, the n value is predetermined, and the pair of (Δm, Δn) value is predetermined.

Layers of a radio interface protocol may be implemented by the processors. The memories are connected with the processors to store various pieces of information for driving the processors. The transceivers are connected with the processors to transmit and/or receive a radio signal. Needless to say, the transceiver may be implemented as a transmitter to transmit the radio signal and a receiver to receive the radio signal.

The memories may be positioned inside or outside the processors and connected with the processors by various well-known means.

In the embodiments described above, the components and the features of the embodiments are combined in a predetermined form. Each component or feature should be considered as an option unless otherwise expressly stated. Each component or feature may be implemented not to be associated with other components or features. Further, the embodiment may be configured by associating some components and/or features. The order of the operations described in the embodiments may be changed. Some components or features of any embodiment may be included in another embodiment or replaced with the component and the feature corresponding to another embodiment. It is apparent that the claims that are not expressly cited in the claims are combined to form an embodiment or be included in a new claim.

The embodiments may be implemented by hardware, firmware, software, or combinations thereof. In the case of implementation by hardware, according to hardware implementation, the exemplary embodiment described herein may be implemented by using one or more application-specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, and the like.

Embodiments may be practiced in other specific forms. The described embodiments are to be considered in all respects to be only illustrative and not restrictive. The scope of the invention is, therefore, indicated in the appended claims rather than by the foregoing description. All changes which come within the meaning and range of equivalency of the claims are to be embraced within their scope.

1. A user equipment (UE) for wireless communication, comprising:
at least one memory; and
at least one processor coupled with the at least one memory and configured to cause the UE to:
receive a downlink control information (DCI) scheduling a physical uplink shared channel (PUSCH) transmitted with eight antenna ports with eight antenna port groups,
wherein the DCI includes a transmit precoding matrix indicator (TPMI) field indicating information on a precoding matrix with a field bitwidth, as follows:
if a max rank is configured to 1, the TPMI field has 3bits,
if the max rank is configured to 2, the TPMI field has 6bits,
if the max rank is configured to 3, the TPMI field has 7bits,
if the max rank is configured to 4, the TPMI field has 8bits,
if the max rank is configured to 5, the TPMI field has 8bits,
if the max rank is configured to 6, the TPMI field has 8bits,
if the max rank is configured to 7, the TPMI field has 8bits,
if the max rank is configured to 8, the TPMI field has 8bits; and
determine the precoding matrix for the scheduled PUSCH according to the TPMI field.

2. The UE of claim 1, wherein the at least one processor is further configured to cause the UE to report the number of antenna port groups.

3. The UE of claim 2, wherein
the TPMI field contains an 8-bit bitmap b₇b₆b₅b₄b₃b₂b₁b₀, where,
the number of non-zero bits in the 8-bit bitmap indicates the number of PUSCH layers of the scheduled PUSCH,
each non-zero bit bᵢ indicates that antenna port 1000+i is used for PUSCH transmission, where i is from 0 to 7, and
the n^{th} PUSCH layer of the scheduled PUSCH is transmitted by the n^{th} indicated antenna port 1000+i beginning from the smallest i of the non-zero bit bᵢ.

4.-13. (canceled)

14. A method performed by a user equipment (UE), the method comprising:
receiving a downlink control information (DCI) scheduling a physical uplink shared channel (PUSCH) transmitted with eight antenna ports with eight antenna port groups,
wherein the DCI includes a transmit precoding matrix indicator (TPMI) field indicating information on a precoding matrix with a field bitwidth, as follows:
if a max rank is configured to 1, the TPMI field has 3bits,
if the max rank is configured to 2, the TPMI field has 6bits,
if the max rank is configured to 3, the TPMI field has 7bits,
if the max rank is configured to 4, the TPMI field has 8bits,
if the max rank is configured to 5, the TPMI field has 8bits,
if the max rank is configured to 6, the TPMI field has 8bits,
if the max rank is configured to 7, the TPMI field has 8bits,
if the max rank is configured to 8, the TPMI field has 8bits; and
determining the precoding matrix for the scheduled PUSCH according to the TPMI field.

15. The method of claim 14, further comprising reporting the number of antenna port groups.

16. The method of claim 15, wherein the TPMI field contains an 8-bit bitmap b₇b₆b₅b₄b₃b₂b₁b₀, where,
the number of non-zero bits in the 8-bit bitmap indicates the number of PUSCH layers of the scheduled PUSCH,
each non-zero bit bᵢ indicates that antenna port 1000+i is used for PUSCH transmission, where i is from 0 to 7, and
the n^{th} PUSCH layer of the scheduled PUSCH is transmitted by the n^{th} indicated antenna port 1000+i beginning from the smallest i of the non-zero bit bᵢ.

17. A base unit for wireless communication, comprising:
at least one memory; and
at least one processor coupled with the at least one memory and configured to cause the base unit to:
transmit a downlink control information (DCI) scheduling a physical uplink shared channel (PUSCH) transmitted with eight antenna ports with eight antenna port groups,
wherein the DCI includes a transmit precoding matrix indicator (TPMI) field indicating information on a precoding matrix with a field bitwidth, as follows:
if a max rank is configured to 1, the TPMI field has 3bits,
if the max rank is configured to 2, the TPMI field has 6bits,
if the max rank is configured to 3, the TPMI field has 7bits,
if the max rank is configured to 4, the TPMI field has 8bits,
if the max rank is configured to 5, the TPMI field has 8bits,
if the max rank is configured to 6, the TPMI field has 8bits,
if the max rank is configured to 7, the TPMI field has 8bits,
if the max rank is configured to 8, the TPMI field has 8bits; and
determine the precoding matrix for the scheduled PUSCH according to the TPMI field.

18. The base unit of claim 17, wherein the TPMI field contains an 8-bit bitmap b₇b₆b₅b₄b₃b₂b₁b₀, where,
the number of non-zero bits in the 8-bit bitmap indicates the number of PUSCH layers of the scheduled PUSCH,
each non-zero bit bᵢ indicates that antenna port 1000+i is used for PUSCH transmission, where i is from 0 to 7, and
the n^{th} PUSCH layer of the scheduled PUSCH is transmitted by the n^{th} indicated antenna port 1000+i beginning from the smallest i of the non-zero bit bᵢ.

19. A user equipment (UE) for wireless communication, comprising:
at least one memory; and
at least one processor coupled with the at least one memory and configured to cause the UE to:
receive a downlink control information (DCI) scheduling a physical uplink shared channel (PUSCH),
wherein the DCI includes a transmit precoding matrix indicator (TPMI) field;
determine the precoding matrix for the scheduled PUSCH according to the TPMI field.

20. The UE of claim 1, wherein the at least one processor is further configured to cause the UE to report the number of antenna groups (Ng).

21. The UE of claim 20, wherein,
If the number of antenna groups (Ng) is 8 for the UE, the TPMI field contains an 8-bit bitmap b₇b₆b₅b₄b₃b₂b₁b₀, where,
the number of non-zero bits in the 8-bit bitmap indicates the number of PUSCH layers of the scheduled PUSCH,
each non-zero bit bᵢ indicates that antenna port 1000+i is used for PUSCH transmission, where i is from 0 to 7, and
the n^{th} PUSCH layer of the scheduled PUSCH is transmitted by the n^{th} indicated antenna port 1000+i beginning from the smallest i of the non-zero bit bᵢ.

22. The UE of claim 20, wherein, if the number of antenna groups (Ng) is 1 for the UE,
the DCI further includes an antenna ports field indicating a number of demodulation reference signal (DMRS) ports that determines a rank of the scheduled PUSCH, and the precoding matrix for the scheduled PUSCH is determined according to the rank and the TPMI field, and
wherein the at least one processor is further configured to cause the UE to report a number of antennas (M) in horizontal, a number of antennas (N) in vertical, and supported pairs of oversampling factors (Oₘ, Oₙ) in horizontal and vertical corresponding to a reported (M, N).

23. The UE of claim 22, wherein, if more than one pair of oversampling factors (Oₘ, Oₙ) is reported, the at least one processor is further configured to cause the UE to:
Receive a configuration to configure a pair of oversampling factors (Oₘ, Oₙ).

24. The UE of claim 23, wherein, if the number of antenna groups (Ng) is 1 for the UE and the UE only supports full-coherent precoding,
the bitwidth of TPMI field is (┌log₂(OₘM)┐+┌log₂(OₙN)┐+2) bits for maxRank=1; and
the bitwidth of TPMI field is (┌log₂(OₘM)┐+┌log₂(OₙN)┐+2+1) bits for maxRank=4 or 8.

25. The UE of claim 24, wherein, if the transmit rank of the scheduled PUSCH is 1,
a m value, a n value and a l value are used for obtaining the precoding matrix for the scheduled PUSCH, and
in the TPMI field, first ┌log₂(OₘM)┐ bit(s) indicate the m value, ┌log₂(OₙN)┐ bit(s) following the ┌log₂(OₘM)┐ bit(s) indicate the n value, and two bits following the ┌log₂(OₙN)┐ bit(s) indicate the l value.

26. The UE of claim 24, if the transmit rank of the scheduled PUSCH is 2 or 3 or 4,
a m value, a n value, a pair of (Δm, Δn) value and a l value are used for obtaining the precoding matrix for the scheduled PUSCH, and
in the TPMI field, first ┌log₂(OₘM)┐ bit(s) indicate the m value, ┌log₂(OₙN)┐ bit(s) following the ┌log₂(OₘM)┐ bit(s) indicate the n value, two bits following the ┌log₂(OₙN)┐ bit(s) indicate the pair of (Δm, Δn) value, and the last one bit indicates the l value.

27. The UE of claim 24, wherein, if the transmit rank of the scheduled PUSCH is 5 or 6,
a m value, a n value, a pair of (Δm, Δn) value and a l value are used for obtaining the precoding matrix for the scheduled PUSCH, and
in the TPMI field, first ┌log₂(OₘM)┐ bit(s) indicate the m value, ┌log₂(OₙN)┐ bit(s) following the ┌log₂(OₘM)┐ bit(s) indicate the n value, and one bit following the ┌log₂(OₙN)┐ bit(s) indicates the l value, where, the pair of (Δm, Δn) value is predetermined.

28. The UE of claim 24, wherein, if the transmit rank of the scheduled PUSCH is 7 or 8 and the pair of (M, N) is (2, 2),
a m value, a n value, a pair of (Δn, Δn) value and a l value are used for obtaining the precoding matrix for the scheduled PUSCH, and
in the TPMI field, first ┌log₂(OₘM)┐ bit(s) indicate the m value, ┌log₂(OₙN)┐ bit(s) following the ┌log₂(OₘM)┐ bit(s) indicate the n value, and one bit following the ┌log₂(OₙN)┐ bit(s) indicates the l value, where, the pair of (Δm, Δn) value is predetermined.

29. The UE of claim 24, wherein, if the transmit rank of the scheduled PUSCH is 7 or 8 and the pair of (M, N) is (4, 1),
a m value, a n value, a pair of (Δm, Δn) value and a l value are used for obtaining the precoding matrix for the scheduled PUSCH, and
in the TPMI field, first
$$⌈ {log}_{2} ( \frac{{O}_{m} M}{2} ) ⌉$$
bit(s) indicate the m value, and one bit following the
$$⌈ {log}_{2} ( \frac{{O}_{m} M}{2} ) ⌉$$
bit(s) indicates the l value, where, the n value is predetermined, and the pair of (Δm, Δn) value is predetermined.
